(19) United States
(12) Patent Application Publication
(10) Pub. No.: US 2005/0188325 A1
(43) Pub. Date: Aug. 25, 2005

(54) Highlighting panning window interface

(76) Inventors: Robert S. Kolman, Longmont, CO (US); Reid Hayhow, LaPorte, CO (US); Daven Walt Septon, Loveland, CO (US)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 10/782,985

(22) Filed: Feb. 20, 2004

(51) Int. Cl. G06F 3/00

(52) U.S. Cl. 715/781; 715/821; 715/822; 715/860; 715/713; 715/852

(57) ABSTRACT

The present invention is a graphical user interface with a panning window interface that allows presentation of a high-level view of a dense graphical map structure simultaneously with a detailed sub-portion of the dense graphical map structure. The graphical user interface provides a movable panning window that allows an operator to select the portion of the overall map structure to view in detail. The detailed view of the selection portion of the overall map structure is presented in a detail panel of the screen. Enhancements to the panning window interface include highlighting of map structure elements on the screen selectable via a highlight selection menu or search and highlight capability.

### BACKGROUND OF THE INVENTION

The present invention relates generally to graphical user interfaces, and more particularly to a panning and highlighting technique for navigation and presentation of detailed information within a dense graphical map structure.

Graphical user interfaces are used in computerized systems to facilitate input and output of information between a computerized device and a human operator of the device. An ideal graphical user interface (GUI) is easily navigable, straightforward in the type and format of input entries required, and presents information received from the computerized device in a format easily understandable by a human operator.

In some applications, the GUI may present a map structure representing, for example, a site map for a website, a device structure or layout, a control flow process, or other such graphical structure representing interrelations between items of interest. Typically, as is often the case in a website map, the map structure is presented as some form of list (e.g., a drop-down list). Items in the list may include subitems, which may in turn include subitems, and so on. Other graphical map structures represent items of interest with an icon or a shape (such as a box) and represent the interrelations between the items of interest via lines, arrows, or some other chosen representation.

Often, due to the pixel and/or font limitations of a display screen, it is not possible to display the entire map structure of interest on the display screen and still present reasonably viewable structural detail of the map. This phenomenon occurs especially when the map structure is fairly dense.

One method of addressing this problem is to provide a scrollbar in the window displaying the map structure. The scrollbar allows the user to pan from one extreme to the other extreme of the map structure. With a dense map structure, the window displays only a portion of the map structure. The portion of the map structure that is displayed depends on the position of the scrollbar, and the contents of the portion displayed are presented such that an operator can easily view and understand the detailed structural content of the displayed portion of the overall map structure. However, the above solution is limited in its ability to present the overall test flow structure while presenting details at the level of interest.

Another prior method for easing navigation of a dense map structure on a display is through the use of bookmarks defined at specific locations within the map structure. However, in order to jump to a location defined by a bookmark, that bookmark must have been previously defined. Therefore, in order to be useful, bookmarks must have been previously defined in locations that are likely to be useful to the operator. Furthermore, each bookmark must be named or otherwise identified such in order to convey to the operator the location in the overall map structure associated with that bookmark.

Another attempt at easing navigation through a dense map structure has been through a search capability provided through a dialog box. In this technique, the operator can select the name of an item in the map structure from a list box of available items. However, a search tool requires the operator to know the name of the item of interest. Alternatively, the search dialog may allow the user to search on a variable of interest or on content of the items represented by the boxes, or on other search criteria. However, again, the search capability requires the user to have some knowledge of the specific variable name, content, or search criteria in order for it to be useful.

Yet another attempt at easing navigation of a dense map structure has been the creation of “group” icons, where each “group” icon represents a number of sub-icons or symbols that are collapsed into the group. When a group icon is selected, the portion of the map structure belonging to the selected group is displayed. The grouping technique reduces the visual complexity of the map structure, thereby reducing the amount of information to be displayed. However, grouping also hides the very structure of the code that may be recognizable.

Accordingly, a need exists for an improved graphical navigational technique of a dense map structure which allows visual display of the overall map structure but also allows display of detailed structure within the overall map structure. It would be desirable if the improved navigational technique would allow simultaneous display of the overall map structure and portions of the detailed sub-structure.

### SUMMARY OF THE INVENTION

The present invention is an improved technique for navigating a dense graphical map structure to be displayed which allows visual display of the overall map structure but also allows display of individual elements and detailed sub-structures within the overall map structure. The invention also allows simultaneous display of the overall map structure and selected detailed sub-structures.

In accordance with the invention, a graphical user interface displayable on a display screen is provided with a panning window interface that includes a high-level map structure panel which displays a map structure rendered according to a first image scale, a panning window displayed in the high-level map structure panel for selecting a sub-portion of the displayed map structure, and a detailed sub-structure panel which renders the selected sub-portion of the map structure according to a second image scale greater than the first image scale. The panning window interface may be turned on or off via a graphical switch such as a checkbox, radio button, or other graphical means on a graphical menu such as a pulldown menu.

The panning window interface may be enhanced by providing a highlight function, for example in the form of a highlight selection menu. The highlight function allows operator input of highlight selection criteria. When highlight selection criteria is selected, elements in the map structure that are displayed in said high-level map structure panel that meet said highlight selection criteria are highlighted. Preferably, when multiple selection criteria are selected, the highlight function provides visual differentiation between elements highlighted according to different respective selection criteria.

The panning window interface may be similarly be enhanced by providing a search and highlight function, for example in the form of a highlight selection menu. The search and highlight function integrates search capability with highlight capability to allow operator input of search criteria. When search criteria is selected, the search and highlight function searches the elements in the map structure to determine whether they meet the search criteria. Elements that do meet the search criteria are highlighted in the high-level map structure panel and detailed sub-structure panel.

### BRIEF DESCRIPTION OF THE DRAWINGS

A more complete appreciation of this invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a perspective view of an automated printed circuit assembly test system;

FIG. 2 is a block diagram illustrating component interaction between the GUI interface and device under test in the test system of FIG. 1;

FIG. 3 is a functional diagram of the test editor of FIG. 1 used to produce the test flow map structure in the illustrative embodiment of the invention;

FIG. 4 is a structural diagram illustrating an example graphical sub-structure representing a single test suite generated by the test editor of FIG. 3;

FIG. 5 is a structural diagram of an example test flow map structure of that may be generated by test flow software in the illustrative embodiment of the invention;

FIG. 6 is an example of a prior art graphical user interface window which presents a test map structure;

FIG. 7 is an example of a graphical user interface window which presents a test map structure using the panning window interface of the invention;

FIG. 8 is the graphical user interface window of FIG. 7 illustrating re-positioning of the panning window from a first position to a second position;

FIG. 9 is the graphical user interface window of FIGS. 7 and 8 illustrating a graphical switch for turning on and off the panning window interface in the form of a drop-down selectable menu item;

FIG. 10 is a flow diagram illustrating an example method for implementing panning window functionality presented in the graphical user interface of FIGS. 7, 8 and 9;

FIG. 11 an example of a graphical user interface window which presents a test map structure using the panning window interface of the invention with highlight function enhancement;

FIG. 12 an example of a graphical user interface window which presents a test map structure using the panning window interface of the invention with search and highlight capability; and

FIG. 13 is a flow diagram illustrating an example method for implementing search and highlight functionality presented in the graphical user interface of FIG. 12.

### DETAILED DESCRIPTION

The present invention is technique for navigating a dense map structure in a graphical user interface which allows visual display of the overall map structure and simultaneous display of selected detailed sub-structures within the overall map structure.

For more understanding, the invention will be discussed in the context of a specific application—namely, a test flow GUI for an automated printed circuit assembly test system. However, it is to be understood that the novel aspects of the claimed invention apply equally to systems of varying applications, and more specifically, to any GUI in which a dense map structure must be presented to convey the overall map structure and in which capability is required for presentation of selected detailed substructures of the overall map structure.

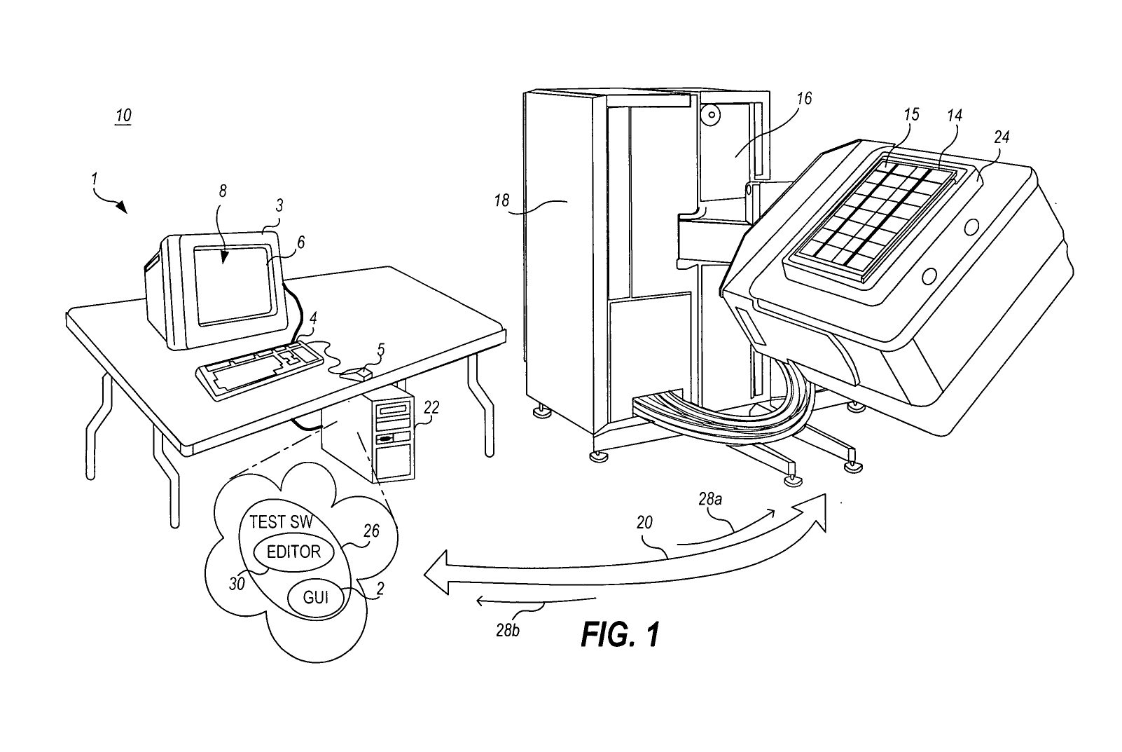

Turning now to the drawings, FIG. 1 is a view of an automated printed circuit assembly test system 10, in particular, an Agilent 93000 Systems-on-a-Chip (SOC) Series test system, manufactured by Agilent Technologies, Inc., of Palo Alto, Calif. The test system 10 comprises a test head 12 for interfacing with and supplying hardware resources to a device under test (DUT) 14, a manipulator 16 for positioning the test head 12, a support rack 18 for supplying the test head 12 with power, cooling water, and compressed air, and a workstation 22.

The test head 12 comprises all the tester electronics, including digital and analog testing capabilities to supply power to the DUT 14 and perform test measurements. The test head 12 includes a DUT interface 24. The device under test (DUT) 14 is mounted on a DUT board 15 which is connected to the I/O channels by the DUT interface 24. The DUT interface 24 consists of high performance coax cabling and spring contact pins (pogo pins) which make electrical contact to the DUT board 15. The DUT interface 24 provides docking capabilities to handlers and wafer probers (not shown). The docking mechanism is controlled by compressed air, but can also be operated manually, if required.

The test head 12 is water cooled. It receives its supply of cooling water from the support rack 18 which in turn is connected by two flexible hoses to a cooling unit (not shown). The manipulator 16 supports and positions the test head 12. It provides six degrees of freedom for the precise and repeatable connection between the test head 12 and handlers or wafer probers. The support rack 18 is attached to the manipulator 16. The support rack 18 is the interface between the test head 12 and its primary supplies (AC power, cooling water, compressed air). For detailed information concerning the internal electronics architecture and connections of the 93000 SOC test system, refer to the SOC Series System Reference, Agilent Technologies, Inc., February 2003, incorporated herein by reference for all that it teaches.

The workstation 22 is the interface between the user and the test head 12. On the Agilent 93000 SOC Series test system, Agilent 93000 SOC Series SmarTest software 26 runs on this workstation 22. The workstation 22 is preferably either a high-performance Unix workstation running the HP-UX operating system or a high-performance PC running the Linux operating system. The workstation 22 is connected to a keyboard 4 and mouse 5 for receiving operator input, and to a display monitor 3 for displaying a graphical user interface (GUI) 8 on the display screen 6 of the monitor 3. The GUI software 2 is integrated into the SmarTest software 26 and generates the GUI 8 on the display screen 6 of the monitor 3.

Communication between the workstation 22 and the test head 12 may be via direct cabling or may be achieved via a wireless communication channel, shown generally at 20. The SmarTest software 26 allows download of setups and test data 28a to the test head 12 and editing of this data. All testing is carried out by the test head 12, and test results 28b are read back by the workstation 22 and displayed on the monitor 3. During test program execution, upload and download are typically unnecessary, since the test head processors act independently of the workstation 22 once the test program is started.

As described, in the preferred embodiment, the test software 26 is Agilent's SmarTest 93000 Series software that allows testing of a device under test (DUT) 14 via a Testflow. As used herein, a Testflow is an interconnected collection of individual tests, called test suites, each one testing a particular parameter. These test suites can be interconnected in a multitude of different ways—sequentially, dependent on the previous/another result, while something is valid, etc. Together, all these test suites form a complete test of a device.

The SmarTest software 26 implements GUI software 2 that includes a graphical editor called the Testflow Editor 30. The Testflow Editor 30 provides menus and dialogues that allow an operator access to all provided functions for creating, modifying and debugging a Testflow. A complete description of the features and capabilities of the SmarTest software may be found in the SmarTest manual, “Agilent 9300 SOC Series: Test Setup-Volume 1-Introduction, Data Manager, Testflow”, Manual Part No. E7050-91010, Agilent Technologies, Inc., Revision 4.2.0, August 2003, incorporated herein by reference for all that it teaches.

Testflows are set up and executed through the Testflow Editor 30 of the SmarTest software 26 running on the workstation 22, which interfaces with the GUI 8 and user input devices keyboard 4 and mouse 5. Testflow icons are selected via mouse selection from within an Insert pulldown menu (not shown). Icons can be manipulated by highlighting icons in an existing testflow and using an Edit menu (not shown).

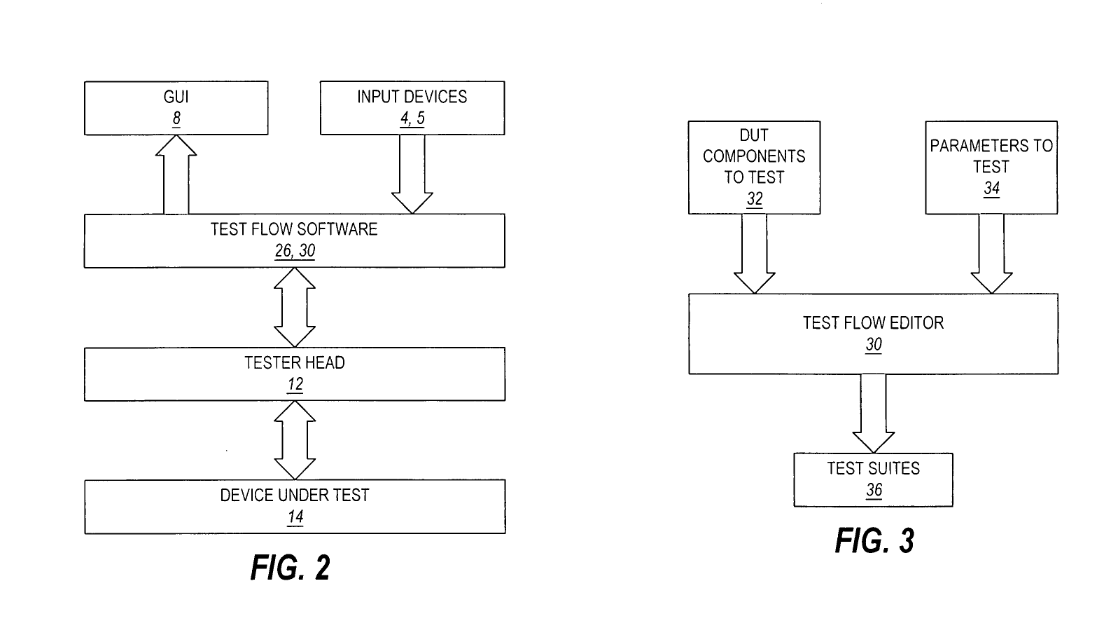

FIG. 2 is a block diagram illustrating the interaction between the GUI interface 8 and DUT 14 in the test system 10 of FIG. 1. As illustrated, the Testflow Editor 30 (running within the SmarTest software 26 on workstation 22) presents the GUI 8 to the operator (via display screen 6 of display 3). The Testflow Editor 30 collects operator input (via keyboard 4 and mouse 5) to set up, download test information and test data, and initiate execution of testflows of the DUT 14 by the test head 12. The test head performs tests of the DUT 14 as instructed by the SmarTest software 26 and collects test results. The test results are uploaded from the test head 12 to the SmarTest software 26, which updates the GUI 8 presented to the operator with the test results.

FIG. 3 diagramatically illustrates the functionality of the Testflow Editor 30. As shown, the Testflow Editor 30 collects information about the components 32 on the DUT 14 to be tested and associated parameters 34 to be tested for each component 32. The Testflow Editor 30 provides a series of dialogues that allow the operator to enter information regarding each device component 32 to be tested and the parameters 34 to be tested on that component 32.

In an illustrative embodiment, the test approach is test function based. In this approach, a set of global setup files containing DUT configuration including pin configuration, timing, levels, vectors, pin attributes, analog control, waveforms and routing, is created for the whole of a given Testflow. Testsuites, based on test functions, are then developed by the operator via a series of Testflow Editor dialogues which test a particular parameter at a time.

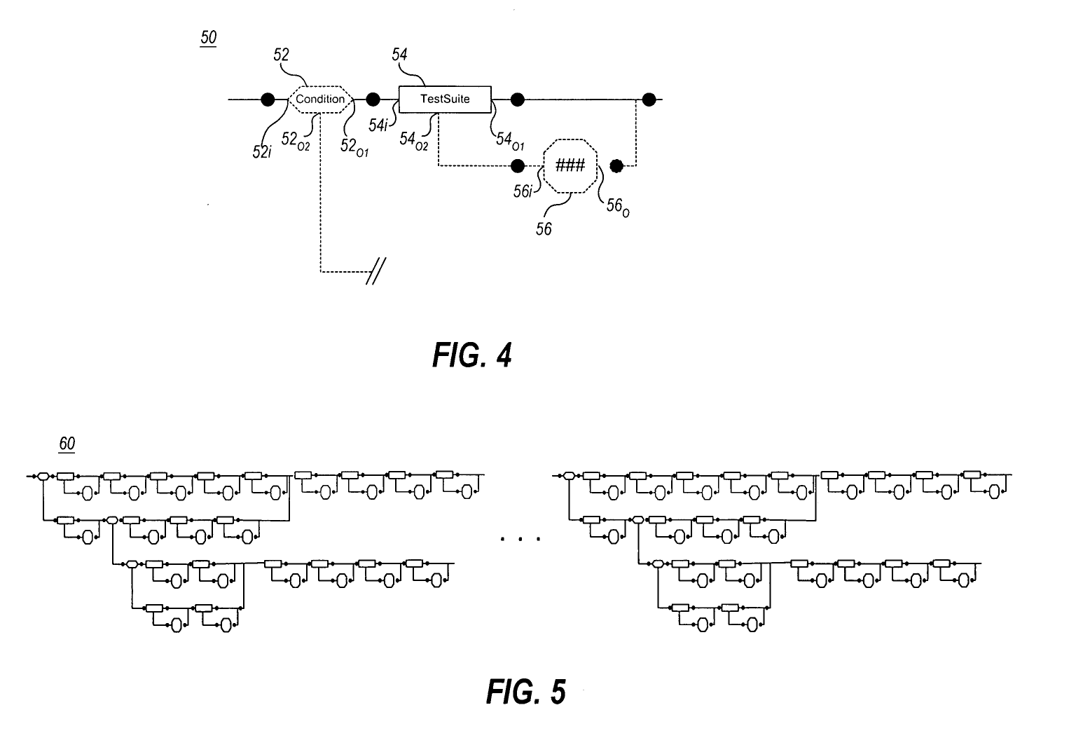

FIG. 4 illustrates an example graphical sub-structure 50 representing a single test suite generated by the test flow editor 30 of FIG. 3.

In the particular embodiment shown, icons 52, 54, 56 are used to represent conditions 52, test suites 54, and bins 56, discussed hereinafter.

Each test suite icon 54, represented by a rectangular shape, represents an individual, independent, executable device test (a functional test, for example). The test may test a single parameter of a single node of the DUT 26, or may test a plurality of parameters of one or more components of the DUT 26. In the illustrative embodiment, the test flow can be made to be, or not to be, dependent on the results of a test suite. If the test flow is not dependent on the results of a given test suite, that test suite is configured as a simple “run” test suite icon. If the test flow is to be made dependent on the results (e.g., pass/fail) of the test suite, the test suite is configured as a “run and branch” test suite icon. The “run” and “run and branch” test suite icons are presented herein for purposes of illustration only. Other test suite icon types beyond the scope of the present invention may be defined. Furthermore, the executable that the icon represents may be any type of executable.

Each bin icon 56, represented by an octagonal or a triangular shape, represents a number of devices that fall into a similar category. For example, in the illustrative embodiment, hexagonal bins are storage bins for listing the device numbers of devices that fail a test suite associated with the bin. Of course, other bin icon types beyond the scope of the present invention may be defined, such as bins that store device identifiers of devices that pass the associated test suite and bins that store device identifiers of devices that have not yet been tested.

Each condition icon 52, represented by a hexagonal shape, represents a condition or set of conditions that determine the flow control of a branch, a while loop, a for loop, a repeat loop, or other flow control.

Each icon 52, 54, 56 includes an input 52ᵢ, 54ᵢ, 56ᵢ, and one or more outputs 52ₒ₁, 52ₒ₂, 54ₒ₁, 54ₒ₂, 56ₒ. The sequence of the test flow is represented by connecting lines, or “connectors” between the outputs of the various icons and inputs of other icons. During execution of a test program, the test flow executes an executable associated with an icon, and moves to the icon whose input is connected to its output. In the test flow example shown, if more than one output exists, only one output will be selected. The selected output typically depends on the results of the executable represented by the icon. For example, referring to the condition icon 52 in FIG. 4, two outputs 52ₒ₁, and 52ₒ₂ exist. However, during execution of the test flow, test flow will pass to only one of the outputs 52ₒ₁ and 52ₒ₂, and the determination of which output the test flow will pass to depends on the results of a conditional test defined in the executable represented by the conditional control flow icon 52. Similarly, test suite icon 54 also has two outputs 54ₒ₁ and 54ₒ₂. During execution of the test flow, test flow passes to only one of the outputs 54ₒ₁ and 54ₒ₂, depending on the results of a conditional test defined in the executable represented by the test suite icon 54. Since one of the outputs 54ₒ₂ is connected to the input of a failure bin 56, output 54ₒ₂ is selected if the test results indicate a failure on the component or pin tested by the executable represented by the test suite icon 54. Otherwise, output 54ₒ₁ is selected.

In the illustrative embodiment, the graphical sub-structure 50 includes a condition icon 52 followed by a test suite icon 54, which includes a device fail bin 56. It will be appreciated that the sub-structure 50 is presented by way of example only and that other structural configurations may be defined. For example, during a full test program, it is unlikely that a conditional control flow icon 52 will need to be executed prior to every test suite. Test suites will typically have one or more bins associated with them to track failures, passes, and/or other information; however, there may be reasons that such information need not be collected for every test suite,for example, information can be stored in a testflow variable or logged to a file.

A typical test program may include hundreds of test suites. FIG. 5 is an example test flow map 60 of an example test program that may be generated by test flow software 28. As illustrated, the test flow map 60 includes a number of test suites (represented by rectangular boxes), conditional tests (represented by hexagonal boxes), and bins (represented by octagonal boxes). Connectors between the test suites, conditional tests, and bins indicate the test flow of the program.

It is well known that the number of icons displayable on a display monitor is limited. Therefore, given a test program of even marginal size, it is unlikely that all condition, test suite, and bin icons representing the test program map structure can be simultaneously presented within a single GUI window.

As described in the background section one method of addressing the problem of limited viewing space in a GUI window is to provide a scrollbar in the window displaying the test flow map. The scrollbar allows the user to change the contents of the test flow map window to any position in the test flow map, displaying only a predefined number of Testflow map icons in the window. Other solutions might be to implement a bookmarking scheme or search capability, also discussed in the background section. However, while each of these solutions allows presentation of the detailed sub-structures, they are limited in their ability to present the overall test flow structure.

An alternative solution is to implement “group” icons, also discussed in the background section, which represent a number of test suite icons that collapsed into the group. However, as pointed out previously, while group icons allow the collapse of the detailed test flow structure into a form displayable on a display monitor, grouping also hides the detailed sub-structure of the overall map structure that may be of interest.

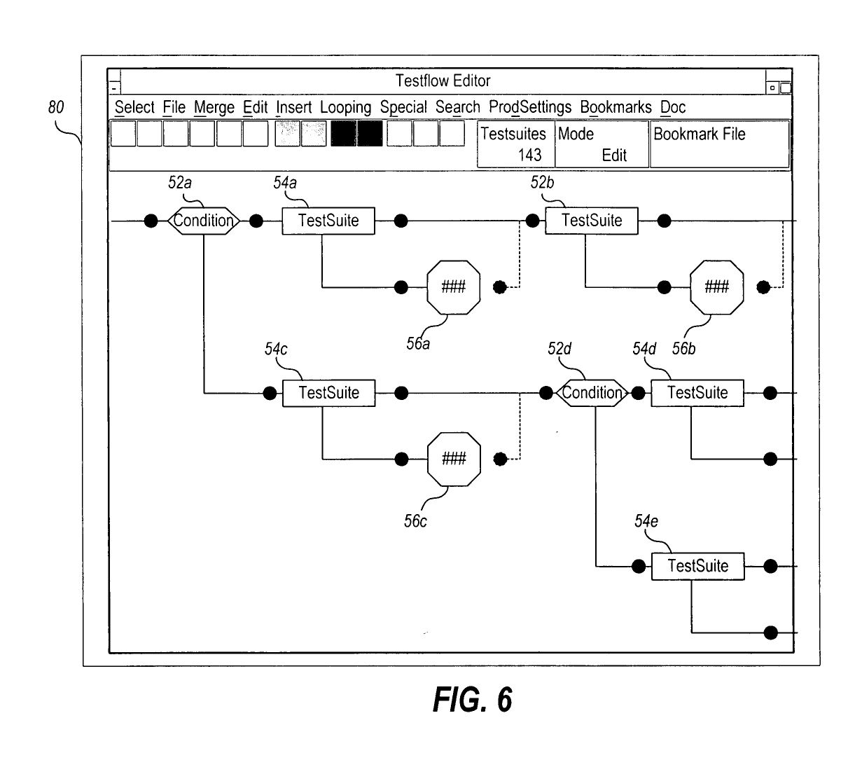

FIG. 6 illustrates an example prior art graphical user interface window 80 presentable on a display monitor 4 which presents a portion of a dense test flow map, such as that illustrated in FIG. 5. As illustrated therein, the displayed portion of the test flow map presents the test flow map structure using the icons and connectors discussed in reference to FIG. 4. Presentation of the test flow map may be used, for example, in a test setup editor to allow a test operator to create and edit the Testflow for testing a particular DUT design. The test flow map structure may include an active icon for each condition, test suite, and bin in the Testflow. In this use, when clicked on by a mouse (or otherwise activated using well-known graphical user interface (GUI) input methods), test setup information associated with the executable represented by the selected icon may be displayed, for example in a pop-up window or another panel, and may be edited.

Presentation of the test flow map structure may also be used, for example, during execution of the test to allow a test operator to monitor the progress of the test flow. The test flow map structure may include an active icon for each condition, test suite, and/or bin. In this use, when clicked on by a mouse (or otherwise activated using well-known graphical user interface (GUI) input methods), test information associated with the execution results of the selected icon may be displayed, for example in a pop-up window or another panel.

Turning now to the details of the displayed portion of the test flow map structure 60 shown window 80 of FIG. 6, test flow control passes to a condition icon 52a on the left-most side of the window 80 from earlier test flow portions of the test program map structure (not shown). Depending on the results of the executed condition, test flow control passes either to test suite icon 54a or to test suite icon 54c. If control passes to test suite icon 54a, the executable represented by test suite icon 54a is executed (and identifiers of components are added to bin 56a if the component fails the test). Test flow control then passes to test suite icon 54b. The executable represented by test suite icon 54b is then executed (and identifiers of components are added to bin 56b if the component fails the test), and test flow control then passes to subsequent test flow portions of the test program map structure not visible in the window 80.

If control instead passes to test suite icon 54c as a result of the condition in the executable represented by conditional control flow 52a, the executable represented by test suite icon 54c is executed (and identifiers of components are added to bin 56c if the component fails the test). Test flow control then passes to conditional flow control 52d. Depending on the results of the executed condition, test flow control passes either to test suite icon 54d or test suite icon 54e. If control passes to test suite icon 54d, the executable represented by test suite icon 54d is executed, and test flow control then passes to subsequent test flow portions of the test program map structure not visible in the window 80. If control passes instead to test suite icon 54e, the executable represented by test suite icon 54e is executed, and test flow control then passes to subsequent test flow portions of the test program map structure 60 not visible in the window 80.

The presentation of test flow map window 80 of FIG. 6 is advantageous in that it presents useful detailed information about the structure of the test flow within the displayed portion of the overall test flow map. The icons 52a, 54a, 56a, 52b, 56b, 54c, 56c, 52d, 54d, 54e and connections therebetween are each large enough to allow the operator viewing the window 80 to understand the test flow of the test program within the displayed portion of the overall test flow map. The icons are also large enough to include text or other features that distinguish them from other icons, which facilitates rapid understanding of the function of the icon by those familiar with the graphical test flow interface.

It is clear from FIG. 6, however, that the test flow map window 80 does not present useful information about the overall structure of the test program map structure 60. In order to navigate the test program map structure, the operator is required to scroll one display screen at a time (which can be overly cumbersome to navigate from one extreme to the other extreme of a dense map structure), or use one of the prior art methodologies discussed in the background section (including bookmarks, searching, and grouping, if the test flow software provides such capabilities). However, none of these methodologies allows the operator to view the overall test flow map structure 60, which would facilitate understanding of the position of the detailed sub-structure displayed in the window 80 in the overall test flow map structure 60.

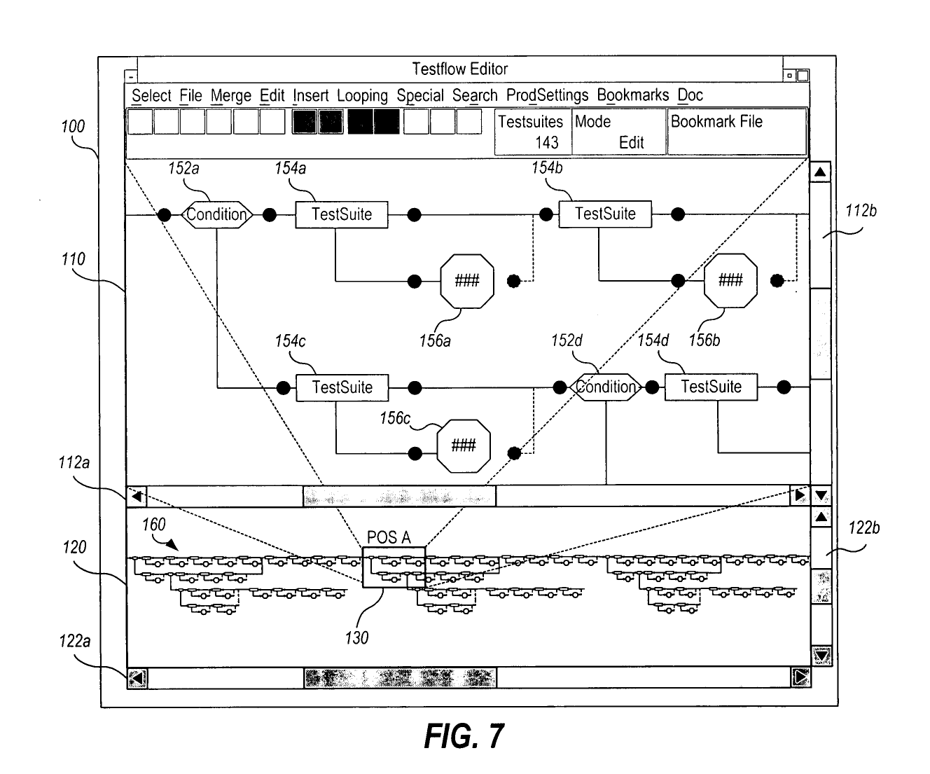

The present invention solves these problems. FIG. 7 shows a window 100 presentable on a display monitor 4 implemented in accordance with a preferred embodiment of the invention for displaying a map structure such as a dense test flow map structure 160. As illustrated therein, the window 100 includes a high-level map structure panel 120 and a detailed sub-structure panel 110. The high-level map structure panel 120 includes a high-level view of a map structure 160 of interest, in this example a test flow map structure 160. The high-level map structure panel 120 includes a panning window 130 that may be positioned over portions of the high-level map structure 160 displayed in the high-level map structure panel 120.

The detailed sub-structure panel 110 presents a large-scale view of the detailed structure of the portion of the high-level map structure 160 enclosed within the panning window 130 of the high-level map structure panel 120.

For example, in FIG. 7, at a position indicated by POS A, panning window 130 encloses a portion of the high-level map structure 160. The contents of the detailed sub-structure panel 110 corresponds to the portion of the high-level map structure 160 enclosed in the panning window 130, but are displayed on a larger scale to more clearly reveal the detailed structure. In particular, in this example, the portion of the high-level map structure 160 enclosed in the panning window 130 includes a condition icon 152a having connectors to each of test suite icons 154a or 154c. Test suite icons 154a and 154c each have a respective fail bin icon 156a, 156c associated with them. The portion of the high-level map structure 160 enclosed in the panning window 130 and displayed in the detailed sub-structure panel 110 also includes test suite icon 154b connected to the output of test suite icon 154a and its associated fail bin icon 156b, and condition icon 152d connected at the outputs of test suite icons 154c followed by test suite icon 154d. As illustrated in FIG. 7, the portion of the high-level map structure 160 enclosed in the panning window 130 of high-level map structure panel 120 is too small to view the detailed information such as text or other information in the icons. The high-level map structure panel 120 with its panning window 130 and the detailed sub-structure panel 110 that displays the corresponding portion of the high-level map structure 160 enclosed in the panning window 130 allows the operator to simultaneously view the overall map structure of the test program and detailed sub-structure information of portions of the high-level map structure 160.

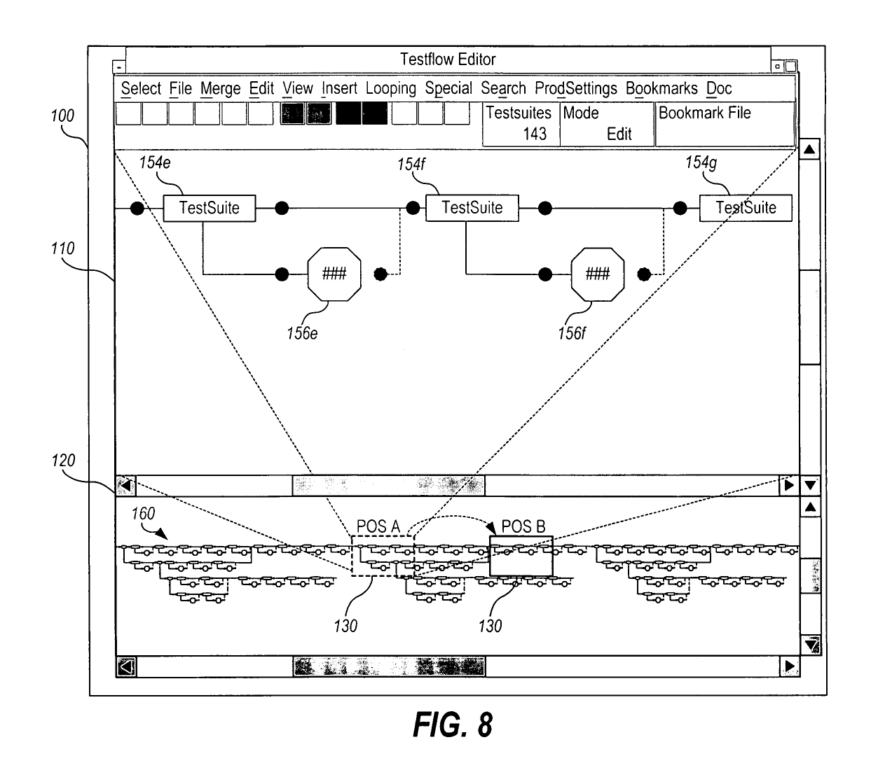

In accordance with the invention, the panning window 130 is movable to allow the operator to select a portion of interest of the high-level map structure 160 that is displayed in the high-level map structure panel 120. In a preferred embodiment, the panning window 130 may be moved using a standard drag-and-drop mouse operation. For example, as illustrated in FIG. 8, panning window 130 is moved from a position indicated by POS A to a position indicated by POS B, as indicated by the connecting dashed arrow. Since the portion of the high-level map structure 160 enclosed in the panning window 130 is changed, the corresponding contents of the detailed sub-structure panel 110 are updated to display on a larger scale the corresponding portion of the high-level map structure 160 enclosed in the panning window 130. Thus, in this example, the detailed sub-structure panel 110 has changed from that shown in FIG. 7, to showing a test suite icon 154e with its associated fail bin icon 156e, followed by a test suite icon 154f with its associated fail bin icon 156f, followed by a test suite icon 154g. Again, the detailed sub-structure and information of portions of the high-level map structure 160 enclosed in the panning window 130 at its new position POS B is clearly viewable by an operator viewing the window 100.

It will be appreciated that the more of overall map structure 160 that can be presented within the high-level map structure panel 120, the easier the navigation of the map structure 160. Accordingly, if the entire map structure 160 can be presented within a single high-level map structure panel 120 without losing the overall detail of the structure, it is preferred to present it as such. However, if the entire high-level map structure 160 cannot be presented within the high-level map structure panel 120 without losing the overall detail of the structure due to limitations of the screen size, font size, and number of pixels, it is contemplated that one of several methods may be employed to maximize operator understanding of the overall test flow map structure while allowing simple navigation therein.

In one embodiment, the high-level test flow map panel may include horizontal and/or vertical scrollbars 122a, 122b (FIGS. 7 and 8) which allow the operator to scroll through the entire high-level test flow map structure by scrolling the scrollbar provided in the panel, typically using a drag-and-drop mouse technique, left- and right-arrow keyboard input, or other means for moving the scrollbar now commonly utilized or utilized in the future. In this embodiment, the panning window 130 may remain in a fixed position on the panel 120 while the underlying high-level map structure 160 is moved across the panel 120 via activation of one or the other of the scrollbars 122a, 122b. The contents of the detailed sub-structure panel 110 are updated to display the detailed structure of the high-level map structure 160 that is enclosed within the panning window 130. Alternatively, both the panning window 130 and underlying high-level map structure 130 are independently moveable via scrolling, drag-and-drop mouse techniques, left- and right-arrow keyboard input, or other means for moving the scrollbar now commonly utilized or utilized in the future.

In another embodiment, the high-level map structure panel 120 may include zoom-in and zoom-out capability which allows the operator to display the overall test flow map at various resolution levels, preferably between a lowest resolution level which displays the entire test flow map in the high-level map structure panel 120 to higher resolutions that present more and more structural and/or readable detail but which may not present the entire high-level map structure 160 within the high-level map structure panel 120. In this embodiment, the panning window 130 is movable via a drag-and-drop mouse technique, scrolling, left- and right-arrow keyboard input, or other means for moving the scrollbar now commonly utilized or utilized in the future, to enclose an area of interest in the high-level map structure 160 displayed in the high-level map structure panel 120.

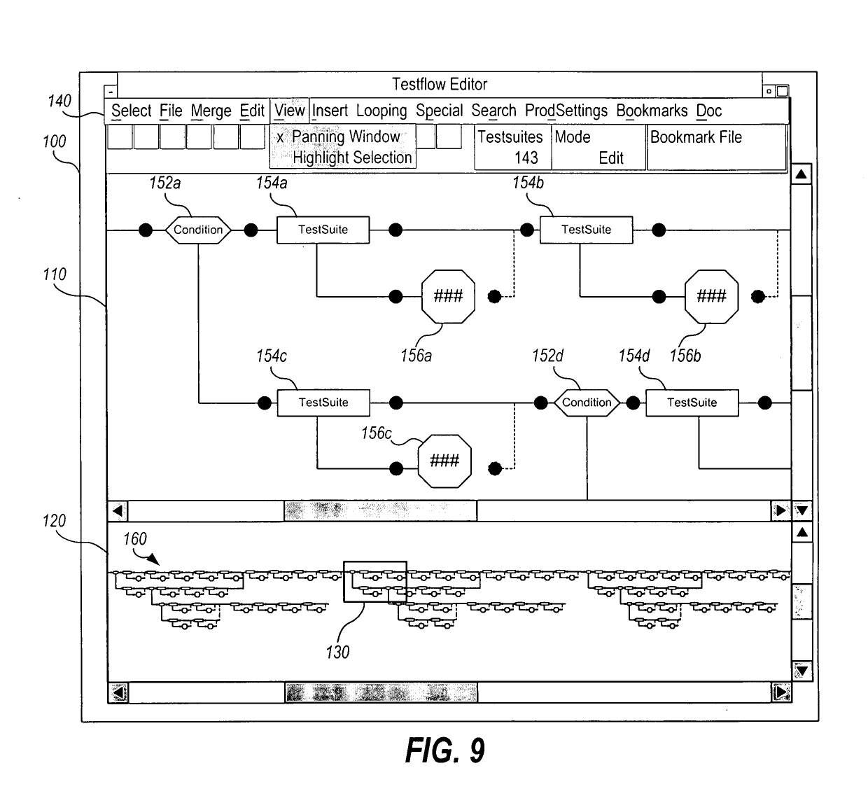

Optionally, the panning window features may be switchably turned on or off. In one embodiment, the panning window features are switchably turned on or off by selecting a sub-item option of a menu. In one example, as illustrated in FIG. 9, a panning window option is presented as a selectable sub-item 144 of a View menu 142 on a toolbar 140. When such an option is available, selecting the panning window option updates the window 100 to a split-screen format that includes the high-level map structure panel 120 with panning window 130 and corresponding detailed sub-structure panel 110, such as illustrated in FIGS. 7, 8, and 9. When the panning window option is deselected, the window may be updated to display a single map structure panel displaying all or a portion of the map structure 160, for example as illustrated in FIG. 6.

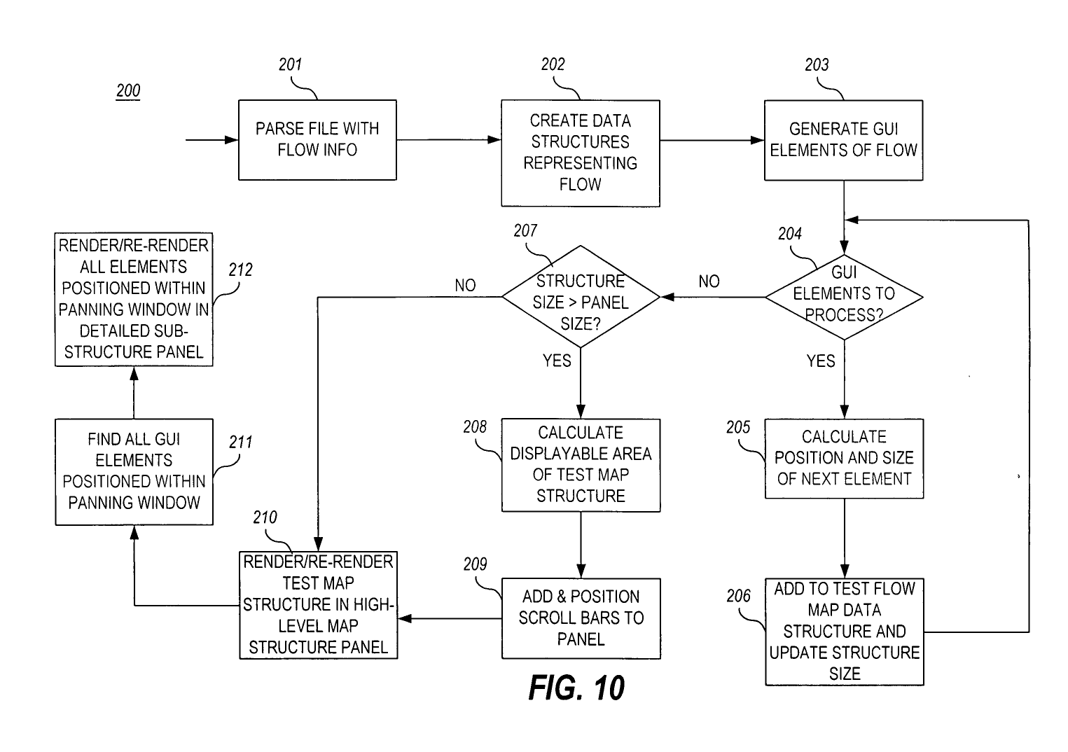

FIG. 10 is a flow diagram illustrating an example method 200 for implementing panning window functionality presented in a graphical user interface 8. In this embodiment, a file containing test flow information such as conditions, test suites, and bins, is received and parsed (step 201) to generate test flow component data structures representing the test flow (step 202). A GUI element corresponding to each test flow component data structure in the test flow map structure potentially to be rendered in the high-level map structure panel 120 is generated (step 203). The method 200 then begins processing each GUI element. The method determines whether any GUI elements still remain to be processed (step 204). If so, the method calculates the position and size of the next GUI element (step 205) and adds it to a test flow map data structure comprising each GUI element in the test flow map structure, relative position of each GUI element within the test flow map structure, and total size required to display all GUI elements (step 206). Steps 204 through 206 are repeated until all GUI elements generated in step 203 are processed. The method 200 then determines (step 207) whether the total size required to display all GUI elements contained in the test flow map data structure is greater than the size of the currently displayed high-level map structure panel 120. If the total size required to display all GUI elements contained in the test flow map data structure is not greater than the size of the currently displayed high-level map structure panel 120 (i.e., if the entire rendered test flow map structure will fit within the high-level map structure panel 120), the panel 120 is rendered (or re-rendered) on the display screen to display all GUI elements contained in the test flow map data structure (step 210). If the total size required to display all GUI elements contained in the test flow map data structure is greater than the size of the currently displayed high-level map structure panel 120 (i.e., if the entire rendered test flow map structure will not fit within the high-level map structure panel 120), the method 200 calculates a portion of the GUI elements contained in the test flow map data structure that will be displayed (for example, by implementing a flag indicating whether or not each respective GUI element should be rendered) in the high-level map structure panel 120 (step 208), and activates and renders scroll bars in the high-level map structure panel 120 (step 209). The panel 120 is then rendered (or re-rendered) on the display screen to display all GUI elements contained in the test flow map data structure (step 210). The method 200 then determines which of the GUI elements in the test flow map data structure lie within the panning window 130 (step 211), and then renders or re-renders the determined GUI elements in the detailed sub-structure panel 110 (step 212).

The panning window interface described above in conjunction with FIGS. 6-10 may be further enhanced with various features described hereinafter. A first enhancement combines search capability with icon highlighting in at least the high-level map structure panel 120, and preferably in the detailed sub-structure panel 110 as well. To this end, it will be appreciated from the high-level map structure panel 120 shown in FIGS. 6-9 that the icons positioned within the panning window 130 may be too small to present textual or graphical information that may help identify sections of the map structure 160 (in this case the test flow). While the textual or other graphical information of the portion of the map structure 160 that is enclosed within the panning window 160 appears in the detailed sub-structure panel 110, in certain applications, the ability to find certain areas of, or icons within, the map structure 160 in a reliable and efficient manner may be useful. For example, in the illustrative embodiment the map structure 160 is that of a test flow, which contains hundreds of test suites. It may be useful to an operator to quickly find a particular test suite or fail bin number. The panning window interface may therefore be enhanced by combining search capability with highlighting capability—that is, the ability for the operator to enter a search criteria (such as the name of a test suite or identifier of a fail bin of interest) and have the panning window interface highlight each particular test suite or fail bin in the map structure 160 of the high-level map structure panel 120 that matches the search criteria. The operator may then quickly identify where in the map structure 160 the particular test suite(s) or fail bin(s) are located, position the panning window 130 over the portion of the map structure 160 that includes the highlighted test suite(s) or fail bin(s), and subsequently see the more detailed view of the selected portion of the map structure 160 containing the selected highlighted test suite(s) or fail bin(s).

The search-and-highlight enhancement to the invention may be implemented in the panning window interface by one of several ways. In one example, the highlighting may be tied to the search engine of the window interface. Accordingly, when the Search menu item on the main toolbar is selected and the operator enters search criteria, if any of the icons displayed in the high-level map structure panel 120 include matches to the search results, the panning window interface highlights the corresponding icons in the panel to allow the operator to examine them more closely (either by selecting a highlighted icon directly from the high-level map structure panel 120 resulting in a pop-up window, or by moving the panning window 130 over the highlighted icon of interest to update the detailed sub-structure panel 110 with the portion of the map structure 160 enclosed in the panning window 130).

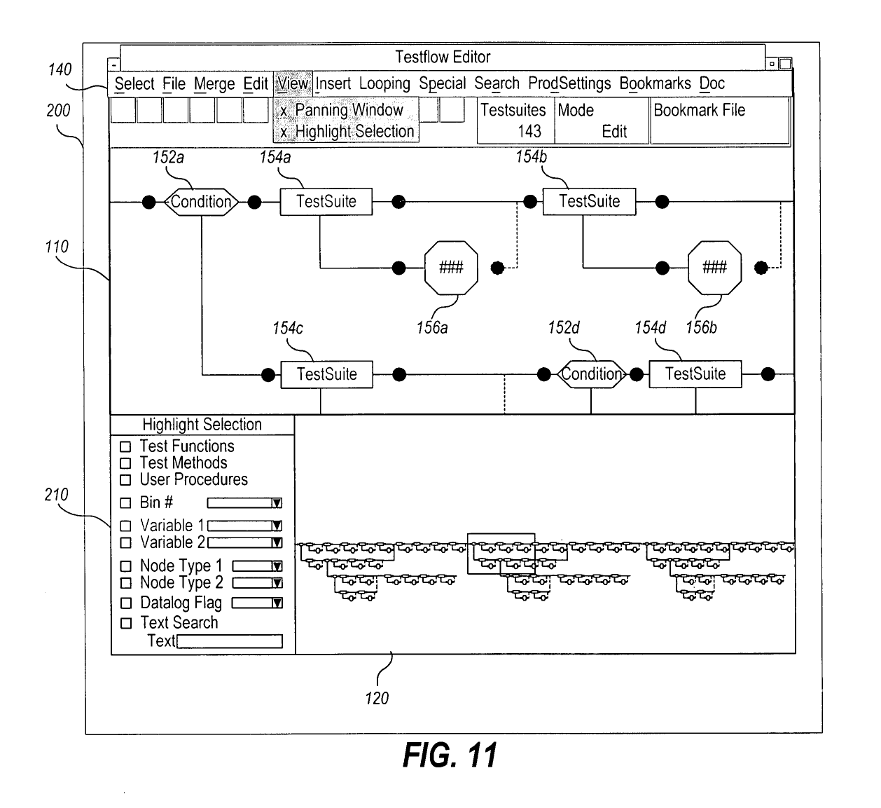

An alternative method for implementing the search and highlight capability is to include a highlight selection menu, either as a menu item in the toolbar or as a separate panel in the window. FIG. 11 shows this last embodiment, illustrating a window 200 that includes the split-screen panning window interface with high-level map structure panel 120 and detailed sub-structure panel 110. This window 200 also includes a highlight selection panel 210 which provides a predefined list of criteria which the operator may use to generate visual correlation information on the map structure 160 in the high-level map structure panel 120. In its simplest embodiment, only one highlight color is used; therefore, only one search criteria may be selected, or alternatively, multiple criteria may be selected but there will be no visual differentiation between highlights generated on the map structure 160 in the high-level map structure panel high-level map structure panel 120 corresponding to one selected criteria and highlights generated on the map structure 160 in the high-level map structure panel high-level map structure panel 120 corresponding to any other selected criteria.

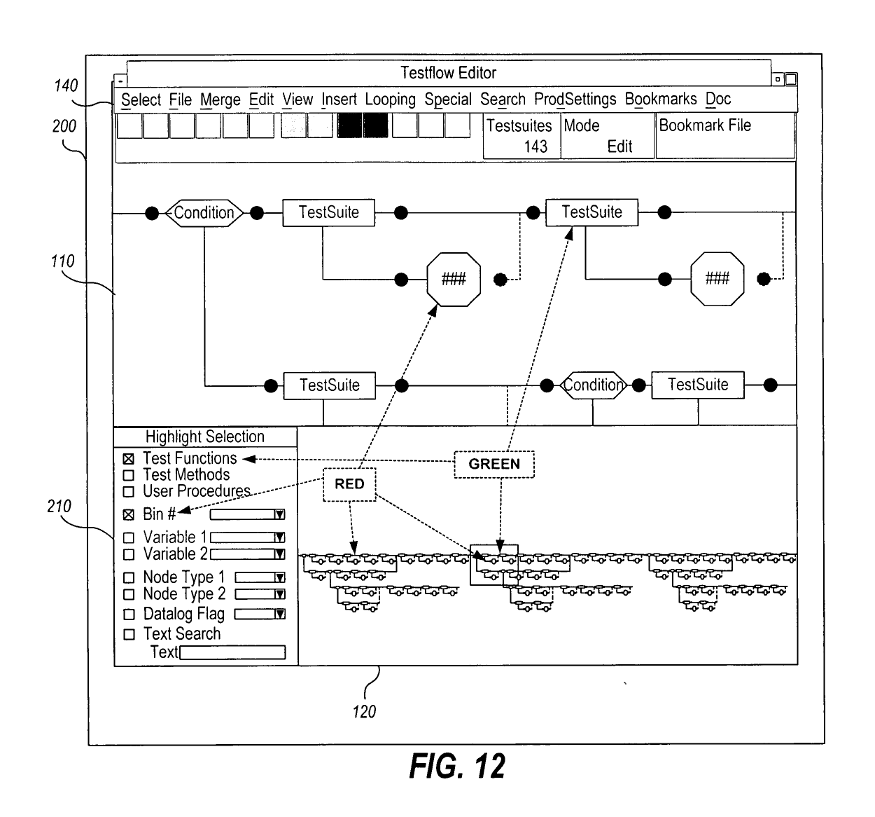

In a more sophisticated embodiment, the search and highlighting capability visually differentiates highlights generated due to one selected search criteria from highlights generated due to other selected search criteria. Highlight differentiation may be implemented using different colors, different line thickness or patterns, or other such visual differentiation techniques known in the art. For example, referring to FIG. 12, two different criteria are selected in the highlight selection panel 210. As illustrated, the “Test Functions” criteria and the “Bin #” criteria with number “123” selected from a drop-down list are selected. Icons in the high-level map structure panel 120 and detailed sub-structure panel 110 that match the search criteria selected in the highlight selection panel are highlighted with the highlight selection criteria differentiated using different colors, namely red and green. In this example, icons that match the “Test Functions” criteria are highlighted in green, and icons that match the “Bin # 123” criteria are highlighted in red. (Note that the RED and GREEN dashed boxes and lines shown in FIG. 12 are provided to indicate the colors of the highlights of the selection criteria and highlighted icons for purposes of this patent and are not actually part of the contents of the window 200 or displayed by the display monitor during actual operation). In this embodiment, the selection criteria are colored to key to the color of their corresponding highlights in the map structure 160.

If line thickness or pattern is used instead to differentiate highlighted icons with respect to selection criteria, a key is preferably presented to allow the operator to visually correlate selected criteria with respective highlighted icons.

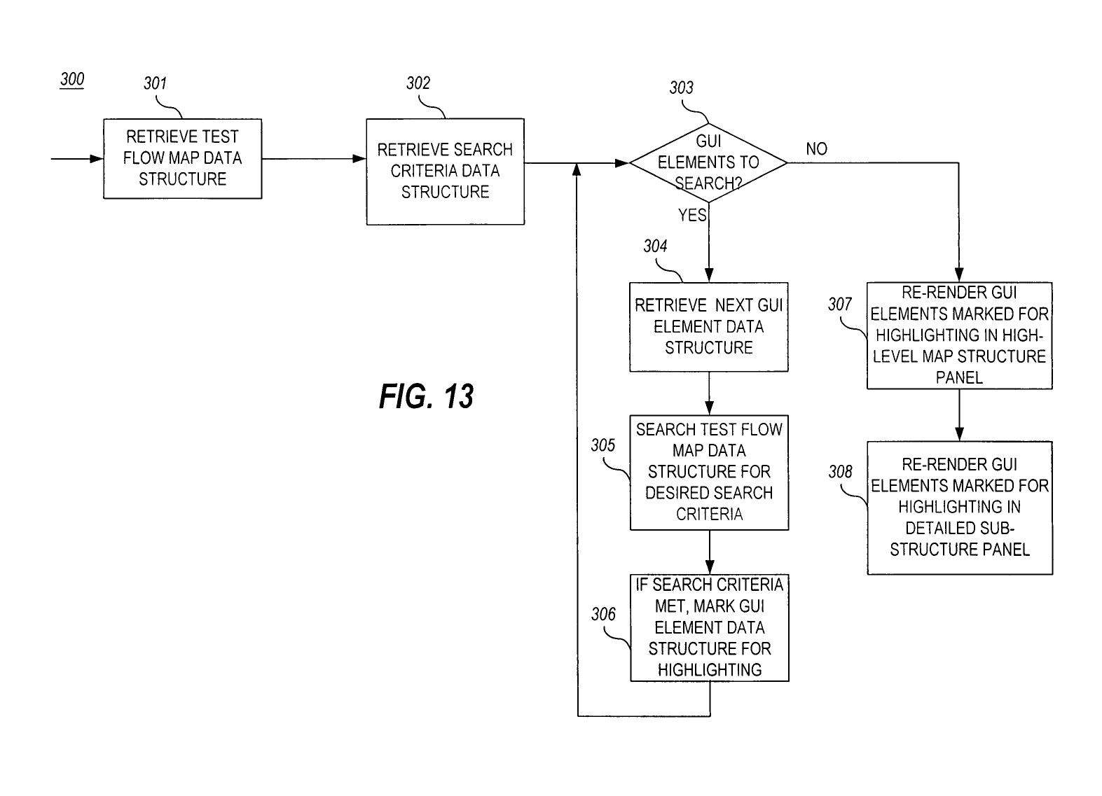

FIG. 13 is a flow diagram illustrating an example method 300 for implementing the search and highlight functionality in the panning window interface of the invention. As illustrated, the method 300 retrieves the test flow structure data structure (step 301) and search criteria data structure containing the search criteria input by the user, for example via the highlight selection menu 210 of FIGS. 11 and 12 (step 302). The method 300 then processes each GUI element in the test flow structure data structure to determine whether it meets the search criteria. To this end, the method 300 determines whether remaining GUI elements exist in the test flow structure data structure (step 303). If so, the method 300 selects and retrieves a next GUI element to be processed (step 304), and then searches the selected GUI element to determine whether it contains the search criteria (step 305). If so, the method 300 marks the selected GUI element for highlighting (step 306). Steps 303 through 306 are repeated until all GUI elements in the test flow structure data structure have been processed. The method 300 then re-renders the GUI elements marked for highlighting in high-level map structure panel 120 (step 307) and re-renders the GUI elements marked for highlighting in detailed sub-structure panel 110 (step 308).

It will be appreciated that addition of a search and highlight capability to the panning window interface improves the utility of the interface. Because the search and highlight capability visually indicates all instances of icons in the displayed map structure 160 that match the search criteria, the operator can more quickly locate the instances searched for. For example, suppose the operator enters the name of a variable in the “Variable 1” selection criteria of the highlight selection panel. The resulting highlighted image in the high-level map structure panel 120 and detailed sub-structure panel 110 will quickly reveal all test suites (and other icons) using the variable. This would make any errant usage of the variable immediately visible to an experienced operator and would allow the problem to be quickly corrected. Furthermore, especially in the case where multiple search criteria are allowed simultaneously, an astute operator can more easily formulate theories or conclusions from the information presented.

Although this preferred embodiment of the present invention has been disclosed for illustrative purposes, those skilled in the art will appreciate that various modifications, additions and substitutions are possible, without departing from the scope and spirit of the invention as disclosed in the accompanying claims. For example, it should be understood that the term “window” or “panel” as used in both the specification and the claims includes any defined section or area of the display screen of a display monitor that displays images to the operator, and that various terminology herein known or hereinafter developed may fit this definition. It is therefore intended that any element or device meeting this definition is included within the meaning of these terms. It is also possible that other benefits or uses of the currently disclosed invention will become apparent over time.

1. A graphical user interface displayable on a display screen, comprising:
a panning window interface comprising:
a high-level map structure panel high-level map structure panel for displaying a map structure on a first image scale;
a panning window for selecting a sub-portion of said displayed map structure; and
a detailed sub-structure panel which displays said selected sub-portion of said map structure on a second image scale greater than said first image scale.

2. A graphical user interface in accordance with claim 1, comprising:
a graphical switch that allows said panning window interface to be activated or inactivated.

3. A graphical user interface in accordance with claim 1, wherein:
said panning window interface comprises a search and highlight function, said search and highlight function allowing input of a search criteria and highlighting elements in said map structure displayed in said high-level map structure panel that meet said search criteria.

4. A graphical user interface in accordance with claim 3, wherein:
said search and highlight function allows input of a plurality of search criteria and highlights elements in said map structure displayed in said high-level map structure panel that meet said search criteria.

5. A graphical user interface in accordance with claim 4, wherein:
said search and highlight function visually differentiates highlights generated according to respective search criteria.

6. A graphical user interface in accordance with claim 3, comprising:
a graphical switch that allows said search and highlight function to be activated or inactivated.

7. A graphical user interface in accordance with claim 1, wherein:
said panning window interface comprises a highlight function, said highlight function allowing input of a highlight selection criteria and highlighting elements in said map structure displayed in said high-level map structure panel that meet said highlight selection criteria.

8. A graphical user interface in accordance with claim 7, wherein:
said highlight function allows input of a plurality of highlight selection criteria and highlights elements in said map structure displayed in said high-level map structure panel that meet said highlight selection criteria.

9. A graphical user interface in accordance with claim 8, wherein:
said highlight function visually differentiates elements highlighted according to different respective highlight selection criteria.

10. A graphical user interface in accordance with claim 7, comprising:
a graphical switch that allows said highlight function to be activated or inactivated.

11. A method for simultaneously displaying a high-level structure of a map structure and a detailed portion of said map structure on a display screen, said method comprising the steps of:
displaying a map structure on a first image scale in a first area of a display screen;
providing a panning window for selecting a sub-portion of said displayed map structure; and
displaying said selected sub-portion of said map structure on a second image scale greater than said first image scale in a second area of said display screen.

12. A method in accordance with claim 11, comprising:
displaying a selectable search and highlight function that accepts search criteria input and highlights elements in said map structure displayed in said first area of said display screen that meet said search criteria input.

13. A method in accordance with claim 12, wherein:
said search and highlight function accepts simultaneous input of a plurality of search criteria and highlights elements in said map structure displayed in said first area of said display screen that meet said search criteria input.

14. A method in accordance with claim 13, further comprising the step of:
visually differentiating highlighted elements highlighted according to different respective search criteria.

15. A method in accordance with claim 11, comprising:
displaying a highlight function that accepts highlight selection criteria input and highlights elements in said map structure displayed in said first area of said display screen that meet said highlight selection criteria input.

16. A method in accordance with claim 15, wherein:
said highlight function accepts simultaneous input of a plurality of highlight selection criteria and highlights elements in said map structure displayed in said first area of said display screen that meet said highlight selection input.

17. A method in accordance with claim 16, further comprising the step of:
visually differentiating highlighted elements highlighted according to different respective highlight selection criteria.
